(19) United States
(12) Patent Application Publication
(10) Pub. No.: US 2010/0060196 A1
(43) Pub. Date: Mar. 11, 2010

(54) DEVICE FOR PROTECTING AGAINST PARASITES

(76) Inventor: Andreas Aicher, Muhldorf (DE)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 12/524,110

(22) PCT Filed: Jan. 23, 2008
(86) PCT No.: PCT/DE2008/000113

§ 371 Date: Nov. 20, 2009

(30) Foreign Application Priority Data
Jan. 24, 2007 (DE) 20 2007 001 349.3

(51) Int. Cl. H05B 37/02; G02B 6/00; F16L 9/00

(52) U.S. Cl. 315/294; 362/551; 138/177

(57) ABSTRACT

The invention relates to a device for protecting against pests, especially in piping systems conveying water, utility lines, and/or ambient air, for example within the water delivery system and/or sewer system of buildings. Said invention enables the inside of a piping system to be illuminated in an energy-saving manner, such that any pests that are normally averse to light will recoil from the light source.

This invention relates to a device for protecting against pests, especially in piping systems conveying water, utility lines, and/or ambient air, for example within the water delivery system and/or sewage system of buildings.

Devices familiar to the art for warding off pests are mostly those that comprise either traps or chemicals used in some way. As a rule the traps are also provided with an attractant, which is intended to attract the pests and then exterminate them. This leads to a number of problems such as, for example, that of the resistance of such water-conveying systems to the chemicals used and/or the questionable toxicological advisability of employing chemicals in water-conveying systems.

The object of the present invention is to provide an absolutely environmentally safe and toxicologically harmless device for warding off pests.

The subject of the invention is a device for protecting against pests, characterized in that the piping system has associated with it at least one light source for the illumination of the pipe interior and/or the pipe outer wall.

According to another embodiment, the light source is amplified by a special optics. To that end, the light source has associated with it at least one optical auxiliary means. The optical auxiliary means can be a reflector, a mirror, or a glass fiber. Also a number of optical auxiliary means can be used in combination with one another for the amplification of the light source. It is thereby also possible to conserve on the illuminants or energy used.

According to one embodiment, the inside of a water-conveying system, for example, is illuminated at one point at least.

The water-conveying system can be, for example, the waste-water or fresh-water piping system of a building, or for example the sewer system of a factory or town.

A piping system for conveying utility lines can, for example, be a cable shaft for power supply lines and/or data lines.

According to one embodiment, the device is part of a water-conveying system that has a light source incorporated on its inner surface.

Moreover this light source can be incorporated into the inner wall in such a way that no water can reach the light source even if the light source itself is not watertight.

According to another embodiment, the source of light is not fixed but moveable, so that not always is the same spot being illuminated. For example, the illumination can be made to move about within the piping system. To that end, a regulating or control system is provided, which activates the various light sources or reflectors or glass fibers at different times.

According to another embodiment, the light source is connected up to be in continuous operation, so as to provide, for example, an unchanging illumination.

For example, a water-conveying system has a number of openings on which closures or covers can be placed, which on their inner side have a light source protected from water. In this way, it is also possible to manually illuminate now one and then another place within a water-conveying piping system.

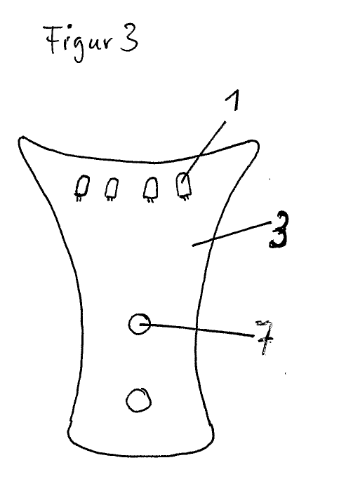

As a specific exemplary embodiment, a water-conveying system that can be so employed is a toilet whose cover, for example, is a customary toilet seat. Then between the toilet seat and the rim of the toilet a light source can be employed that shines a light on the water-conveying plumbing. The light source can also be incorporated directly into the toilet seat. For example, a light source such as is shown below in FIG. 3 can be employed for that purpose.

The light source is, for example, a light-emitting diode, which because of its long service life can be usefully employed here. All types of modern light sources can be employed here, for example light sources that are based on polymer electronics, such as organic light-emitting diodes, among others. But it is just as suitable for other light sources to be used, such as neon rods, gas discharge lamps, halogen lamps, incandescent bulbs, laser lamps, or the like.

The device based on the invention can, for example, provide for light sources (direct or indirect, for example by way of glass fibers or reflectors) in fume hoods, ventilation ducts, air-discharge shafts, air-conditioning chambers, suspended ceilings, coffered ceilings and floors, cable shafts, power-supply shafts, data-cable shafts, socket outlets, and/or switch outlets.

According to one useful embodiment, within the water-conveying piping system there are observation ports through which it is possible to check how the illumination is functioning within the system. On the other hand, a single glass fiber can be conveyed out from the light source within the system in such a way as to form an external light source that gives rise to a cross-sectional illumination of the piping system.

According to one embodiment, opposite the light source, which as said can also be a glass fiber, in addition a reflecting element or some other amplifying element is introduced, thus making it possible to conserve on illumination means and on costs.

In what follows the invention is explained further on the basis of 3 figures:

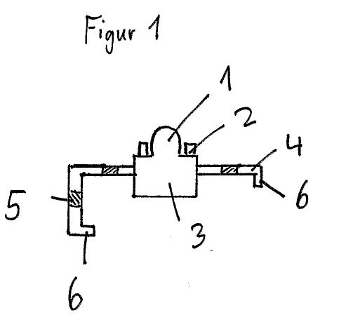

FIG. 1 shows an illustrative embodiment in cross section,

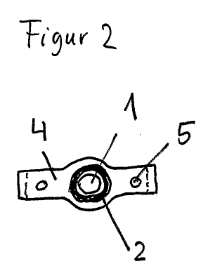

FIG. 2 shows the top view of the relevant embodiment, and

FIG. 3 shows another embodiment of the invention.

Depicted in FIG. 1 is a light source that can be associated with a piping system, consisting of at least one LED 1. The LED 1 is encircled by a sealing ring 2, so that the impermeability of the piping system is preserved. The LED 1 and the sealing ring 2 are enclosed by a housing 3, which contains contacts and/or power sources/energy storage devices and optionally also a control electronics. Preferably at least one mounting support 4 is attached to the housing 3, with this support having, for example, fixation arrangements 5 such as boreholes or suction cups. In some embodiments, tongues 6 are also provided, by means of which the position of the mounting support 4 and housing 3 can be adjusted.

FIG. 2 shows the same embodiment as FIG. 1, only in the view from above: Again depicted is the at least one LED 1, encircled by the sealing ring 2, to which is attached the housing 3 with fixation arrangements 5.

Finally, FIG. 3 shows another embodiment, in which an element with housing 3 comprises at least one light source 1, with fixation arrangements 7 being provided that permit a varying irradiation from above of the piping interior, for example that of a toilet, a shower, or a sink. For example, in the one case the housing may be directly configured in such a way that it fits between the toilet seat and the rim of the toilet on which the toilet seat rests. But the same element can be mounted on the inner wall of a shower, in order to illuminate from above the interior of the shower drain plumbing.

The pests in question can be, for example, cockroaches, which are extremely averse to light. But other pests, including ants, beetles, and even rodents such as mice and rats, can also be warded off via energy-efficient light sources in accordance with the invention.

According to one embodiment, the light source can be switched on and off repeatedly when in operation, so that the pests cannot become habituated to the illumination. On the other hand the color of the light source can be changed periodically, so that here also the pests do not develop habituation to the light. This can be effected by the control or regulating electronics. Finally, depending on the particular embodiment, any habituation to the light source by such pests can be prevented by changing the angle of irradiation.

According to one embodiment the light source is connected to a control or regulating electronics that, for example, can control and/or regulate either manually or automatically the intensity, wavelength, duration, and color and/or color saturation of the light emitted by the light source.

According to one embodiment, the system is transparent at the place illuminated and/or has on it a transparent place that can be illuminated from outside.

Likewise a closure on the system or a valve can be transparent and capable of being illuminated from outside.

According to another embodiment, insertion slots are introduced into the system, for example in connection with standardized pipes and prefabricated modules, with illumination being provided by a special illuminant optics and/or specially directed reflectors. This is useful especially when the system is accessible only from one side.

According to one embodiment, a spotlight of some type is aimed at an opening of the system, such as for example an opening in a drain pipe.

Just as concealed pipes can be equipped with light sources by this invention, so also exposed water-conveying piping systems or for example systems mounted on the wall of a block of houses can be provided with the device based on the invention.

In what follows the invention is explained in more detail by means of two illustrative embodiments:

According to one embodiment, an LED protected against water is mounted on the inside of a drain pipe in such a way that the entire pipe cross section is illuminated along a line. For cockroaches, for example, this creates an impassable barrier.

According to another embodiment, it is useful for the light source to be focused in such a way that a high light intensity is created within a small space. For example, the light source acts like a narrow but strong light band having the nature of a light barrier.

The invention enables the interior of a piping system to be illuminated in an energy-conserving fashion in such a way that any pests that are normally averse to light recoil from the light source.

1. Device for protecting against pests, comprising:
a piping system including at least one pipe for conveying water, the system including utility lines and/or ambient air; and
associated with the piping system at least one light source for the illumination of the at least one pipe interior and/or pipe outer wall.

2. Device according to claim 1 wherein the light source has associated with it at least one optical auxiliary arrangement.

3. Device based according to claim 2 wherein the at least one light source and/or an auxiliary arrangement for the light source is attached to a control or regulating electronics for operating the light source.

4. Device according to claim 1 wherein the wavelength, intensity, and/or duration of light emission of the light source is regulated independently of one another and including an arrangement for said regulation.

5. Device according to claim 1 wherein the at least one light source is incorporated directly or indirectly within the interior of a water-conveying pipe.

6. Device according to claim 1 wherein the pipe has a wall, the wall consists of a transparent material onto which the light is directed.
